(19) United States
(12) Patent Application Publication
(10) Pub. No.: US 2024/0029943 A1
(43) Pub. Date: Jan. 25, 2024

(54) EMI Magnetic Bead Inductor

(71) Applicant: Steward (Foshan) Magnetics Co., Ltd., Foshan (CN)

(72) Inventors: Jacken ZHANG, Foshan City (CN); Yeat Shing CHIANG, Foshan City (CN)

(21) Appl. No.: 18/221,629

(22) Filed: Jul. 13, 2023

(30) Foreign Application Priority Data
Jul. 25, 2022 (CN) 2022108761912

(51) Int. Cl. H01F 27/28; H01F 27/26

(52) U.S. Cl. CPC H01F 27/2828; H01F 27/26; H01F 2017/008

(57) ABSTRACT

An EMI magnetic bead inductor comprises a magnetic core and at least one metal pin group. The metal pin group includes at least one first metal pin. The first metal pin has two first inserting portions and one first connecting portion. First ends of the two first inserting portions are connected by the first connecting portion. The magnetic core is provided with a plurality of insertion holes. Second ends of the two first inserting portions are inserted into two said insertion holes from first ends of the two said insertion holes and protrude from second ends of the two said insertion holes.

### CROSS-REFERENCE TO RELATED APPLICATION

This application claims the benefit of and priority to Chinese Patent Application Number 202210876191.2 filed Jul. 25, 2022. The entire disclosure of this Chinese patent application is incorporated herein by reference.

### FIELD

The present disclosure relates to inductive elements, and more particularly to an electromagnetic interference (EMI) magnetic bead inductor.

### BACKGROUND

This section provides background information related to the present disclosure which is not necessarily prior art.

The electromagnetic interference (EMI) magnetic bead inductor is a most common element in electronic devices and an important component in circuits. The EMI magnetic bead inductor is formed by winding a coil on a magnetizer. At present, the widely used EMI magnetic bead inductor with a single-turn design is of low cost and easy to be assembled, but it is difficult to achieve a higher impedance in a frequency band of dozens of megahertz, resulting in a poor electromagnetic interference suppression performance in this frequency band. In order to increase the impedance, a multi-turn coil is mounted in a magnetic core so as to dispose the magnetic core as a split structure, and after the coil is assembled, two split magnets are assembled as a whole, but due to an assembly gap therebetween, the electromagnetic interference suppression performance of the EMI magnetic bead inductor is seriously reduced.

### SUMMARY

This section provides a general summary of the disclosure, and is not a comprehensive disclosure of its full scope or all of its features.

In exemplary embodiments, an EMI magnetic bead inductor comprises a magnetic core and at least one metal pin group. The metal pin group includes at least one first metal pin. The first metal pin has two first inserting portions and one first connecting portion. First ends of the two first inserting portions are connected by the first connecting portion. The magnetic core is provided with a plurality of insertion holes. Second ends of the two first inserting portions are inserted into two said insertion holes from first ends of the two said insertion holes and protrude from second ends of the two said insertion holes.

Further areas of applicability will become apparent from the description provided herein. The description and specific examples in this summary are intended for purposes of illustration only and are not intended to limit the scope of the present disclosure.

### DRAWINGS

The drawings in the present disclosure are provided for illustration of selected examples only, rather than all possible embodiments, and are not intended to limit the scope of the present disclosure.

FIG. 1 is an exploded view of an EMI magnetic bead inductor according to a first embodiment of the present disclosure.

FIG. 2 is a top view of the EMI magnetic bead inductor according to the first embodiment of the present disclosure shown in FIG. 1 after being assembled.

FIG. 3 is a bottom view of the EMI magnetic bead inductor shown in FIG. 2.

FIG. 4 is a top view of a magnetic core according to a second embodiment of the present disclosure.

FIG. 5 is a bottom view of the magnetic core according to the second embodiment of the present disclosure shown in FIG. 4.

FIG. 6 is a diagram of an assembly of a metal pin group and a magnetic core according to the second embodiment of the present disclosure.

FIG. 7 is a schematic diagram of a connection of a metal pin group according to the second embodiment of the present disclosure.

FIG. 8 is a schematic diagram of an assembly of an EMI magnetic bead inductor and a base according to the second embodiment of the present disclosure.

FIG. 9 is a schematic diagram of a connection of a magnetic core according to a third embodiment of the present disclosure.

FIG. 10 is a schematic diagram of an assembly of a metal pin group and a magnetic core according to the third embodiment of the present disclosure.

FIG. 11 is a performance graph of an EMI magnetic bead inductor according to the first embodiment of the present disclosure shown in FIGS. 1, 2, and 3.

FIG. 12 is a performance graph of an EMI magnetic bead inductor according to the second embodiment of the present disclosure shown in FIGS. 4 through 8.

FIG. 13 is a performance graph of an EMI magnetic bead inductor according to the third embodiment of the present disclosure shown in FIGS. 9, 10, and 11.

### DETAILED DESCRIPTION

Example embodiments will now be described more fully with reference to the accompanying drawings.

The present disclosure provides exemplary embodiments of EMI magnetic bead inductors so as to solve the technical problem that it is difficult for the EMI magnetic bead inductor at present to achieve a high impedance in a low frequency band.

In exemplary embodiments, an EMI magnetic bead inductor comprises a magnetic core and at least one metal pin group. The metal pin group includes at least one first metal pin. The first metal pin has two first inserting portions and one first connecting portion. First ends of the two first inserting portions are connected by the first connecting portion. The magnetic core is provided with a plurality of insertion holes. Second ends of the two first inserting portions are inserted into two said insertion holes from first ends of the two said insertion holes and protrude from second ends of the two said insertion holes.

In an exemplary embodiment of the present disclosure, the metal pin group further includes at least one second metal pin. The second metal pin has one second inserting portion and one second connecting portion. A first end of the second inserting portion is inserted into one said insertion hole from a second end of the one said insertion hole and protrudes from a first end of the one said insertion hole. A second end of the second inserting portion is connected to a first end of the second connecting portion. A second end of the second connecting portion is connected to a second end of the first inserting portion. And the metal pin group is wound around the magnetic core in a shape of coil.

In an exemplary embodiment of the present disclosure, the metal pin group includes two said second metal pins. The two said second metal pins are located at two sides of the first metal pin. The second ends of the two said second connecting portions are respectively connected to two second ends of two said first inserting portions.

In an exemplary embodiment of the present disclosure, the second end of the first inserting portion is provided with a first welding leg. The second end of the second connecting portion is provided with a second welding leg. The first welding leg and the second welding leg abut against each other and are connected by welding.

In an exemplary embodiment of the present disclosure, the magnetic core is provided with at least one first limiting groove and at least one second limiting groove. One said first limiting groove is communicated with the first ends of two said insertion holes. The first connecting portion is disposed in the first limiting groove. One said second limiting groove is communicated with the second end of another said insertion hole. The second connecting portion is disposed in the second limiting groove.

In an exemplary embodiment of the present disclosure, the metal pin group includes at least two said first metal pins. The second end of one said first inserting portion of one said first metal pin is connected to the second end of one said first inserting portion of another said first metal pin. The metal pin group is wound around the magnetic core in a shape of coil.

In an exemplary embodiment of the present disclosure, the second end of one of the first inserting portions of one said first metal pins and the second end of one of the first inserting portions of another said first metal pins are bent toward and lapped in a row and connected by welding.

In an exemplary embodiment of the present disclosure, the magnetic core is provided with at least one third limiting groove. The third limiting groove is communicated with two said insertion holes. The second ends, connected by welding, of two said first inserting portions of two said first metal pins are placed side by side in the third limiting groove.

In an exemplary embodiment of the present disclosure, the EMI magnetic bead inductor comprises two metal pin groups.

In an exemplary embodiment of the present disclosure, the metal pin group includes one said first metal pin and one third metal pin. The third metal pin has two third inserting portions and one third connecting portion. First ends of the two third inserting portions are connected by the third connecting portion. Second ends of the two third inserting portions are inserted into two said insertion holes from the second ends of the two said insertion holes and protrude from the first ends of the two said insertion holes. The first connecting portion is arranged between the two third inserting portions of the third metal pin at an interval. The second ends of both of the two third inserting portions are capable of bending towards and abutting against the mounting surface of the magnetic core with avoiding the first connecting portion. The third connecting portion is arranged between the two first inserting portions of the first metal pin at an interval. The second ends of both of the two first inserting portions are capable of bending towards and abutting against the mounting surface of the magnetic core with avoiding the third connecting portion.

Exemplary embodiments of the present disclosed may be configured to have one or more of the following characteristics and advantages. In exemplary embodiments of the EMI magnetic bead inductor, the two first inserting portions of the first metal pin are directly inserted into the insertion holes on the magnetic core and wound on the magnetic core in cooperation with the first connecting portion, so that the assembly is easy, the magnetism of the magnetic core can be fully utilized, and the length wound on the magnetic core is also increased, thereby improving the anti-interference performance of the EMI magnetic bead inductor in a frequency band of dozens of megahertz.

In exemplary embodiments of the EMI magnetic bead inductor, at least one first inserting portion of the first metal pin is connected to the second inserting portion of at least one second metal pin, so that the metal pin group is wound on the magnetic core in a shape of coil, which further increases the winding length of the metal pin group on the magnetic core. In addition, both the first metal pin and the second metal pin can be directly inserted into the magnetic core, without needing to arrange the magnetic core as a split structure, thus avoiding the affection of the assembly gap of the magnetic core on the performance of the EMI magnetic bead inductor, and further improving the anti-interference performance of the EMI magnetic bead inductor in a frequency band of dozens of megahertz.

In exemplary embodiments of the EMI magnetic bead inductor, the first inserting portions of the at least two first metal pins are connected, so that the metal pin group is wound on the magnetic core in a shape of coil, which further increases the winding length of the metal pin group on the magnetic core. In addition, the at least two first metal pins are both directly inserted into the magnetic core, without needing to arrange the magnetic core as a split structure, thus avoiding the affection of the assembly gap of the magnetic core on the performance of the EMI magnetic bead inductor, and further improving the anti-interference performance of the EMI magnetic bead inductor in a frequency band of dozens of megahertz.

In exemplary embodiments of the EMI magnetic bead inductor, the one first metal pin and the one third metal pin are inserted from two ends of the magnetic core, respectively, so that the magnetism of the magnetic core can be fully utilized, and the two first inserting portions of the first metal pin and the two third inserting portions of the third metal pin can be bent and extended longer, thereby increasing the lengths of the first metal pin and the third metal pin which are wound on the magnetic core, respectively, and improving the anti-interference performance of the EMI magnetic bead inductor in a frequency band of tens of megahertz.

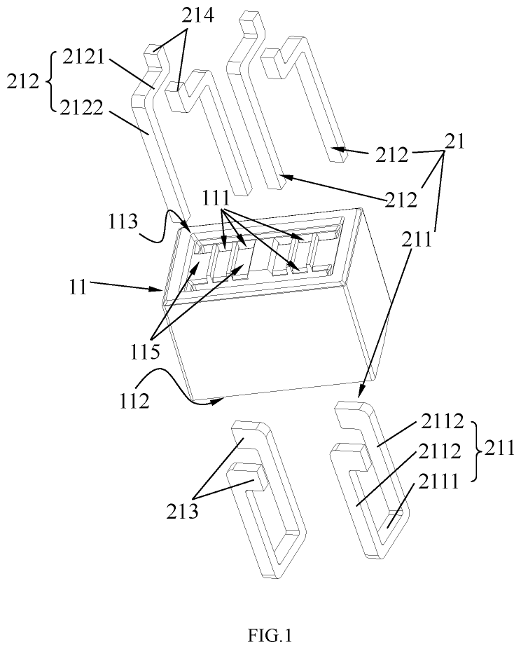

With reference to the figures, FIGS. 1, 6 and 10 illustrate exemplary embodiments of an EMI magnetic bead inductor that includes a magnetic core and at least one metal pin group. The metal pin group includes at least one first metal pin. The first metal pin has two first inserting portions and a first connecting portion. First ends of the two first inserting portions are connected by the first connecting portion. The magnetic core is provided with a plurality of insertion holes. Second ends of the two first inserting portions are inserted into two insertion holes from first ends of the two insertion holes and protrude from second ends of the two insertion holes.

In exemplary embodiments of the EMI magnetic bead inductor, the two first inserting portions of the first metal pin are directly inserted into the insertion holes on the magnetic core and wound on the magnetic core in cooperation with the first connecting portion. Accordingly, the assembly is relatively non-complicated, the magnetism of the magnetic core can be fully utilized, and the length wound on the magnetic core is increased, thereby improving the anti-interference performance of the EMI magnetic bead inductor in a frequency band of dozens of megahertz.

In an exemplary embodiment, the first metal pin is generally U-shaped. The magnetic core has a cuboid structure. The insertion hole passes through a first side surface and a second side surface of the magnetic core which are opposite to each other. The first end of the insertion hole is located on the first side surface. The second end of the insertion hole is located on the second side surface. The first inserting portion is inserted into the first side surface of the magnetic core and protrudes from the second side surface thereof. The magnetic core has a winding region around which the plurality of insertion holes are distributed, so that the two first inserting portions of the first metal insertion pin can pass through the two insertion holes and be wound on the winding region.

In the first exemplary embodiment as illustrated in FIGS. 1, 2, and 3, a metal pin group 21 further includes at least one second metal pin 212. The second metal pin 212 has a second inserting portion 2122 and a second connecting portion 2121. A first end of the second inserting portion 2122 is inserted into one insertion hole 111 from a second end of the one insertion hole 111 and protrudes from a first end of the one insertion hole 111. Accordingly, the second inserting portion 2122 is inserted into the second side surface 113 of the magnetic core 11 and protrudes from the first side surface 112 thereof, and the first inserting portion 2112 is inserted into the first side surface 112 of the magnetic core 11 and protrudes from the second side surface 113 thereof. A second end of the second inserting portion 2122 is connected to a first end of the second connecting portion 2121. A second end of the second connecting portion 2121 is connected to a second end of the first inserting portion 2112. And the metal pin group 21 is disposed (e.g., wound, coiled, etc.) around the magnetic core 11 in a shape of coil.

In exemplary embodiments of the EMI magnetic bead inductor, at least one first inserting portion 2112 of the first metal pin 211 is connected to the second inserting portion 2122 of at least one second metal pin 212, so that the metal pin group 21 is disposed (e.g., wound, coiled, etc.) on the magnetic core 11 in a shape of coil, which further increases the winding length of the metal pin group 21 on the magnetic core 11. In addition, both the first metal pin 211 and the second metal pin 212 can be directly inserted into the magnetic core 11, without needing to arrange the magnetic core 11 as a split structure, thus avoiding the affection of the assembly gap of the magnetic core 11 on the performance of the EMI magnetic bead inductor, and further improving the anti-interference performance of the EMI magnetic bead inductor in a frequency band of dozens of megahertz. Compared with a conventional EMI magnetic bead inductor of the same type, the impedance of the EMI magnetic bead inductor of the present disclosure is significantly increased in the frequency band of dozens of megahertz. As illustrated in FIG. 11, the dotted line represents a performance curve of the conventional EMI magnetic bead inductor of the same type, and the solid line represents a performance curve of the EMI magnetic bead inductor of the present disclosure. Under an environment of 25° C., the impedance of the EMI magnetic bead inductor of the present disclosure is increased by about 100Ω to 300Ω in the frequency band of dozens of megahertz.

In exemplary embodiments of the EMI magnetic bead inductor, a winding region 116 on the magnetic core 11 generally has a cuboid structure. The plurality of insertion holes 111 are arranged in two rows at intervals along a length direction X of the winding region 116. The second metal pin 212 generally has an L-shaped structure. The first connecting portion 2111 is arranged on one side of the magnetic core 11 along a width direction Y of the winding region 116, and the second connecting portion 2121 is arranged on the opposite side of the magnetic core 11 along the width direction Y of the winding region 116. The second inserting portion 2122 of the second metal pin 212 and the first inserting portion 2112 of the first metal pin 211 connected thereto are located on the opposite sides of the winding region 116, respectively, so that the metal pin group 21 is disposed (e.g., wound, coiled, etc.) around the magnetic core 11 in a shape of coil.

In the first exemplary embodiment as illustrated in FIGS. 1 to 3, the metal pin group 21 includes two second metal pins 212 located on the two sides of the first metal pin 211. The second ends of the two second connecting portions 2121 are connected to the two second ends of the two first inserting portions 2112, respectively. By connecting the two second metal pins 212 to the two first inserting portions 2112 of the first metal pin 211, respectively, the winding length of the metal pin group 21 on the magnetic core 11 is further increased, thereby forming a coil structure with two turns. The first ends of the two second inserting portions 2122 form two pin ends of the metal pin group 21. Alternatively, one metal pin group may be provided with one first metal pin and one second metal pin that are configured to form a coil structure with 1.5 turns. Alternatively, one metal pin group may be provided with two or more first metal pins and two or more second metal pins assembled in the same way above that are configured to form a coil structure with more turns.

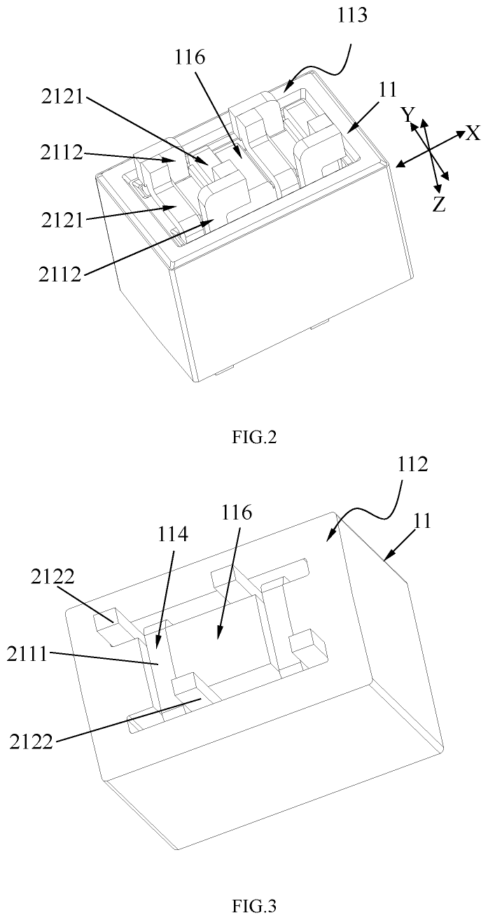

As illustrated in FIGS. 1 and 2, the second end of the first inserting portion 2112 is provided with a first welding leg 213. The second end of the second connecting portion 2121 is provided with a second welding leg 214. The first welding leg 213 and the second welding leg 214 abut against each other and are connected by a weld. By providing the first welding leg 213 and the second welding leg 214, the welding area between the first inserting portion 2112 and the second connecting portion 2121 is increased, thereby allowing for improved welding reliability and providing more operation for a welding head to weld. In an exemplary embodiment, the second end of the second connecting portion 2121 extends upwards (upwards in a direction Z) to be flush with the second end of the first inserting portion 2112 to form the second welding leg 214. The second ends of the two first inserting portions 2112 extend towards the second connecting portions 2121 on the two sides until the second welding leg 214 to thereby form the first welding leg 213.

As illustrated in FIGS. 1 and 3, the magnetic core 11 is provided with at least one first limiting groove 114 and at least one second limiting groove 115. One first limiting groove 114 is communicated with the first ends of two insertion holes 111. The first connecting portion 2111 is disposed in the first limiting groove 114. One second limiting groove 115 is communicated with the second end of another insertion hole 11. And the second connecting portion 2121 is disposed in the second limiting groove 115. The first metal pin 211 and the second metal pin 212 are limited by the first limiting groove 114 and the second limiting groove 115, so as to avoid the contact between the first inserting portion 2112 and the second inserting portion 2122.

In the first embodiment as illustrated in FIGS. 1, 2, and 3, the EMI magnetic bead inductor includes two metal pin groups 21, so that the EMI magnetic bead inductor has four pin ends. The magnetic core 11 is provided with two groups of insertion holes 111. Each group of insertion holes 111 includes four insertion holes 111 distributed in a parallelogram array. Two first inserting portions 2112 of one first metal pin 211 are inserted into two insertion holes 111 in the middle. And two second inserting portions 2122 of two second metal pins 212 are inserted into the insertion holes 111 on the two sides.

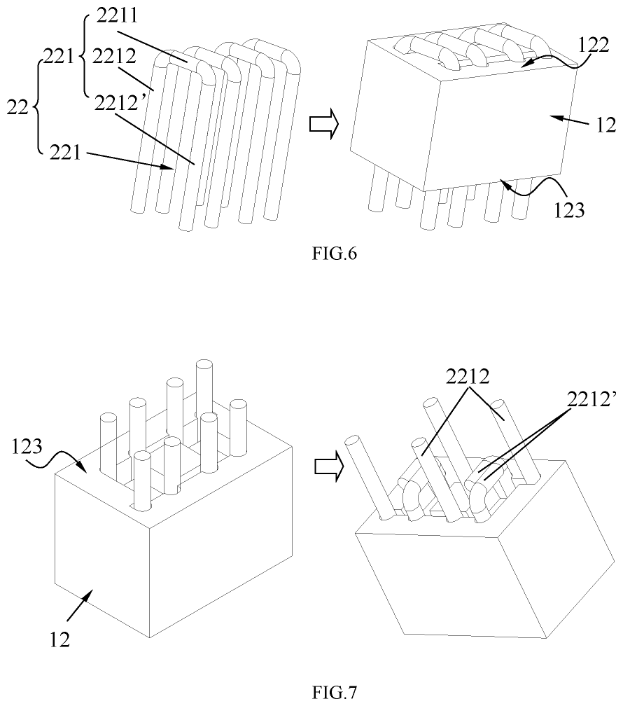

As illustrated in FIGS. 6 and 7 for the second embodiment, a metal pin group 22 includes at least two first metal pins 221. A second end of one first inserting portion 2212′ of one first metal pin 221 is connected to a second end of one first inserting portion 2212′ of another first metal pin 221. And the metal pin group 22 is disposed (e.g., wound, coiled, etc.) on the magnetic core 12 in a shape of coil.

In exemplary embodiments of the EMI magnetic bead inductor, the first inserting portions 2212′ of the at least two first metal pins 221 are connected, so that the metal pin group 22 is disposed (e.g., wound, coiled, etc.) on the magnetic core 12 in a shape of coil, which further increases the winding length of the metal pin group 22 on the magnetic core 12. In addition, the at least two first metal pins 221 are both directly inserted into the magnetic core 12, without needing to arrange the magnetic core 12 as a split structure, thus avoiding the affection of the assembly gap of the magnetic core 12 on the performance of the EMI magnetic bead inductor, and further improving the anti-interference performance of the EMI magnetic bead inductor in a frequency band of dozens of megahertz. Compared with a conventional EMI magnetic bead inductor of the same type, the impedance of the EMI magnetic bead inductor of the present disclosure is significantly increased in the frequency band of dozens of megahertz. As illustrated in FIG. 12, the dotted line represents a performance curve of the conventional EMI magnetic bead inductor of the same type, and the solid line represents a performance curve of the EMI magnetic bead inductor of the present disclosure. Under an environment of 25° C., the impedance of the EMI magnetic bead inductor of the present disclosure is increased by about 60Ω to 200Ω in the frequency band of dozens of megahertz.

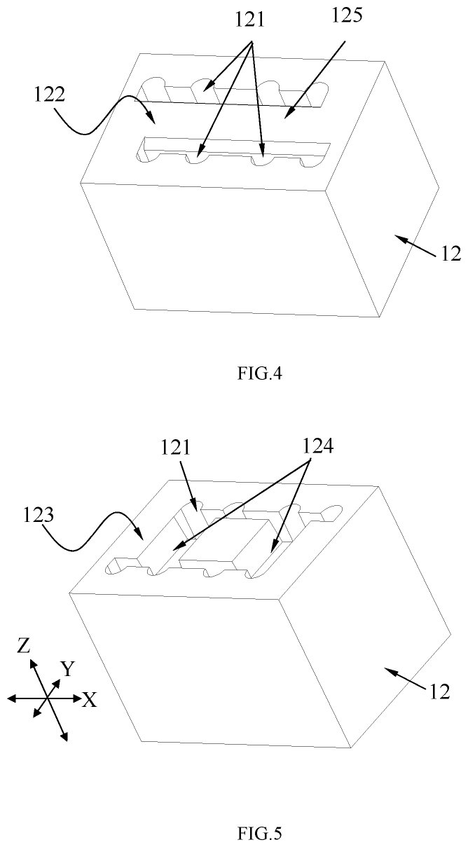

As illustrated in FIGS. 4 and 5, a winding region 125 on the magnetic core 12 generally has a cuboid structure. The plurality of insertion holes 121 are arranged in rows at intervals along a length direction X of the winding region 125. And two rows of insertion holes 121 are arranged at intervals along a width direction Y thereof. Two connected first inserting portions 2212′ of the two first metal pins 221 are located at two sides of the winding region 125, so that the metal pin group 22 is disposed (e.g., wound, coiled, etc.) around the winding region 125 of the magnetic core 12 in a shape of coil.

As illustrated in FIGS. 7 and 8, the second ends of the first inserting portions 2212′ of the two first metal pins 221 are bent towards each other and lapped in a row and connected by a weld, so that the second ends of the first inserting portions 2212′ of the two first metal pins 221 is in line contact, thereby increasing the welding area and improving the welding reliability. In addition, both the first inserting portion 2212 and the first inserting portion 2212′ are inserted from a first side surface 122 of the magnetic core 12 and extended from a second side surface 123 thereof. A distance is reserved between a bending part of the second end of the first inserting portion 2212′ and the second side surface 123 of the magnetic core 12, so that the magnetic core 12 will not be affected by a stress when the second end of the first inserting portion 2212′ is clamped by a clamp for bending.

As illustrated in FIGS. 5, 7 and 8, the magnetic core 12 is provided with at least one third limiting groove 124, which is communicated with two insertion holes 121. And the second ends, connected by a weld, of two first inserting portions 2212′ of two first metal pins 221 are placed side by side in the third limiting groove 124. The two first metal pins 221 are limited by the third limiting groove 124 in a horizontal direction. After the second ends of the two first inserting portions 2212′ are bent, the two first metal pins 221 are slid in a height direction Z, so that the second ends of the two first inserting portions 2212′ are lapped in the third limiting groove 124 side by side, and then the second ends of the two first inserting portions 2212′ lapped side by side are connected by a weld. The EMI magnetic bead inductor further includes a base 32 fixed on the second side surface 123 of the magnetic core 12. The unconnected second ends of two first inserting portions 2212 on the two first metal pins 221 pass through the base 32 to form two pin ends of the metal pin group 22. The second ends of the two first inserting portions 2212′ lapped side by side are limited and fixed in the third limiting groove 124 in the height direction Z through the base 32.

In the second embodiment as illustrated in FIGS. 4 and 6, the EMI magnetic bead inductor includes two metal pin groups 22, so that the EMI magnetic bead inductor has four pin ends. The magnetic core 12 is provided with two groups of insertion holes 121. Each group of insertion holes 121 includes four insertion holes 121 distributed in a parallelogram array. And four first metal pins 221 are arranged in parallel and inserted into the corresponding insertion holes 121. As illustrated in FIG. 8, the second ends of the four first inserting portions 2212 of the four first metal pins 221 pass through the base 32 to form four pin ends.

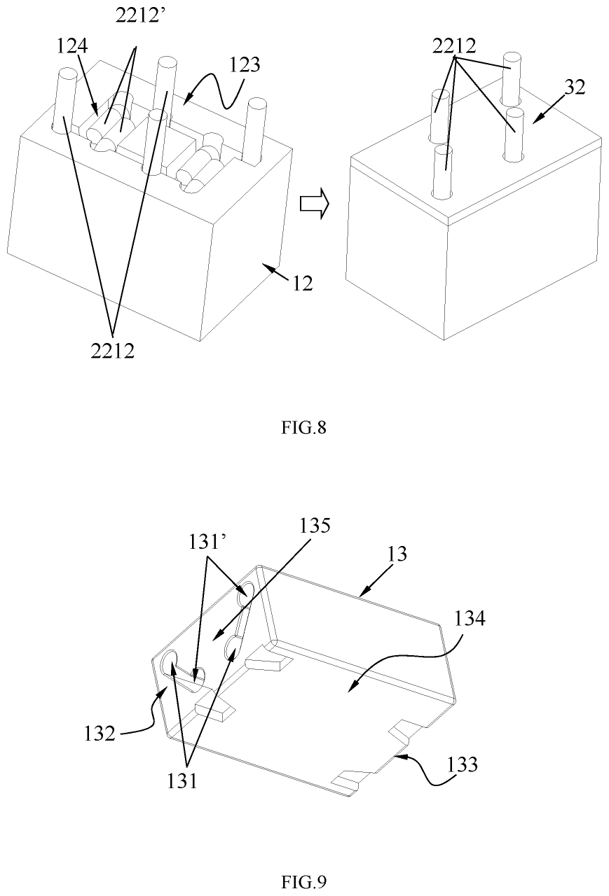

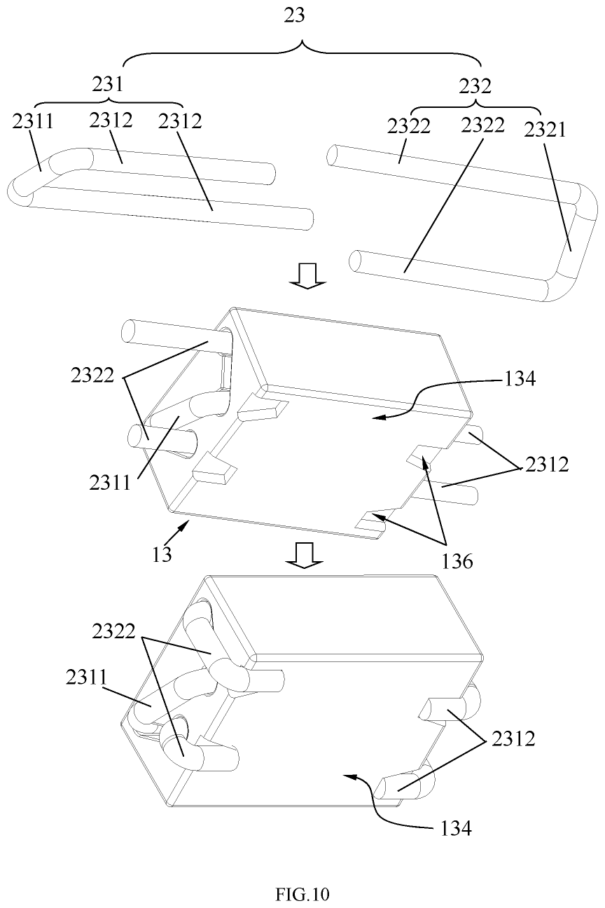

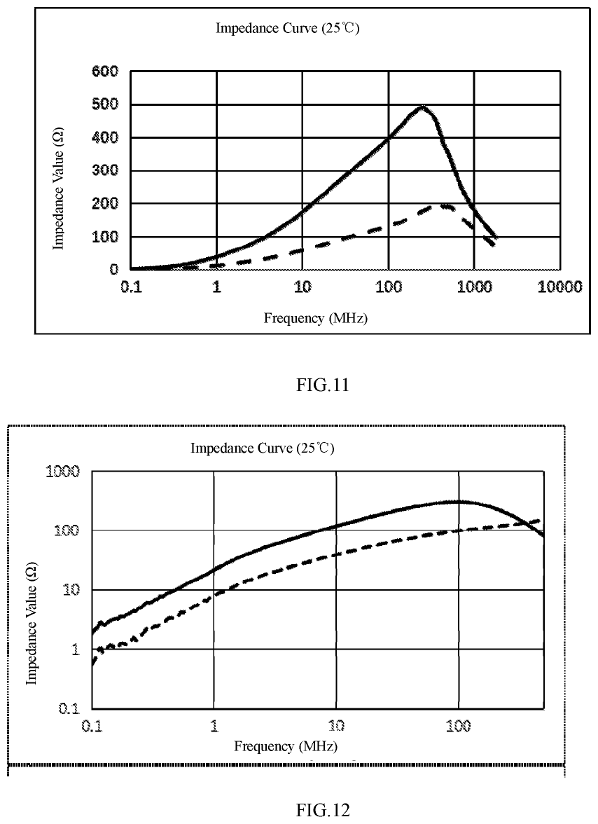

In the third embodiment as illustrated in FIGS. 9 and 10, a metal pin group 23 includes one first metal pin 231 and one third metal pin 232. The third metal pin 232 has two third inserting portions 2322 and one third connecting portion 2321. First ends of the two third inserting portions 2322 are connected by the third connecting portion 2321. Second ends of the two first inserting portion 2312 are inserted into two insertion holes 131 from first ends of the two insertion holes 131 and protrude from second ends of the two insertion holes 131. Second ends of the two third inserting portions 2322 are inserted into two insertion holes 131′ from second ends of the two insertion holes 131′ and protrude from first ends of the two insertion holes 131′. The first connecting portion 2311 is arranged between the two third inserting portions 2322 of the third metal pin 232 at an interval. The second ends of both of the two third inserting portions 2322 are configured to be capable of bending towards and abutting against a mounting surface 134 of a magnetic core 13 while avoiding the first connecting portion 2311. The third connecting portion 2321 is arranged between the two first inserting portions 2312 of the first metal pin 231 at an interval. The second ends of both of the two first inserting portions 2312 are configured to be capable of bending towards and abutting against the mounting surface 134 of the magnetic core 13 with avoiding the third connecting portion 2321.

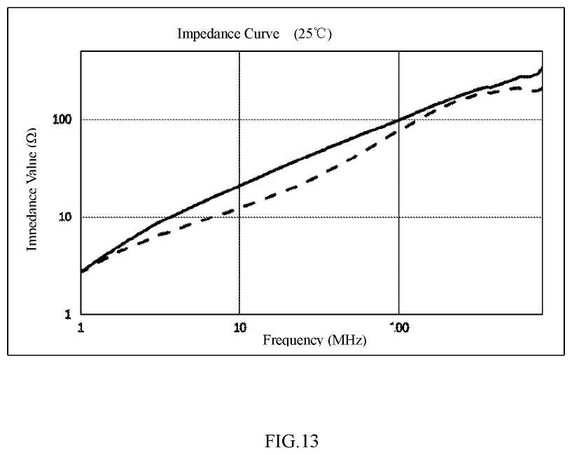

In exemplary embodiments of the EMI magnetic bead inductor, the first metal pin 231 and the third metal pin 232 are inserted from two ends of the magnetic core 13, respectively, so that the magnetism of the magnetic core 13 can be fully utilized, and the two first inserting portions 2312 of the first metal pin 231 and the two third inserting portions 2322 of the third metal pin 232 can be bent and extended longer towards the mounting surface 134 of the magnetic core 13, thereby increasing the lengths of the first metal pin 231 and the third metal pin 232 which are disposed (e.g., wound, coiled, etc.) on the magnetic core 13, respectively, and improving the anti-interference performance of the EMI magnetic bead inductor in a frequency band of tens of megahertz. Compared with a conventional EMI magnetic bead inductor of the same type, the impedance of the EMI magnetic bead inductor of the present disclosure is increased in the frequency band of dozens of megahertz. As illustrated in FIG. 13, the dotted line represents a performance curve of the same type of conventional EMI magnetic bead inductor, and the solid line represents a performance curve of the EMI magnetic bead inductor of the present disclosure. Under an environment of 25° C., the impedance of the EMI magnetic bead inductor of the present disclosure is increased by about 10Ω to 30Ω in the frequency band of dozens of megahertz.

In exemplary embodiments of the EMI magnetic bead inductor, the third metal pin 232 has a generally U-shaped structure. The first metal pin 231 and the third metal pin 232 have the same structure, but the insertion directions thereof are different. The third inserting portion 2322 is inserted from the second side surface 133 of the magnetic core 13 and protrudes from the first side surface 132, while the first inserting portion 2312 is inserted from the first side surface 132 of the magnetic core 13 and protrudes from the second side surface 133. By inserting the first metal pin 231 and the third metal pin 232 with the U-shaped structures into the magnetic core 13 in a staggered manner, the second ends of the two first inserting portions 2312 of the first metal pin 231 and the two third inserting portions 2322 of the third metal pin 232 are capable of bending towards and abutting against the mounting surface 134 of the magnetic core 13, so that the first metal pin 231 and the third metal pin 232 form a coil structure with 1.5 turns, and the winding region 135 becomes larger to better utilize the magnetism of the magnetic core 13. The magnetic core 13 is provided with two insertion holes 131 and two insertion holes 131′, all of which are distributed in an isosceles trapezoid array, wherein the two first inserting portions 2312 of the first metal pin 231 are inserted into two insertion holes 131 which are diagonally distributed, and the two third inserting portions 2322 of the third metal pin 232 are inserted into the other two insertion holes 131′ which are diagonally distributed. The second ends of the two first inserting portions 2312 of the first metal pin 231 form two pin ends. And the second ends of the two third inserting portions 2322 of the third metal pin 232 form the other two pin ends. The mounting surface 134 of the magnetic core 13 abuts against the circuit board, and the four pin ends are connected to the circuit board. The mounting surface 134 of the magnetic core 13 is provided with four fourth limiting grooves 136, in which the four pin ends are arranged.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electromagnetic interference (EMI) magnetic bead inductor comprising:
a magnetic core including a plurality of insertion holes having first ends and second ends; and
at least one metal pin group including at least one first metal pin,
wherein:
the at least one first metal pin includes a first connecting portion and two first inserting portions having first ends and second ends;
the first ends of the two first inserting portions are connected by the first connecting portion; and
the second ends of the two first inserting portions are disposed within two said insertion holes of the magnetic core so as to extend from the first ends of the two said insertion holes and protrude from the second ends of the two said insertion holes.

2. The EMI magnetic bead inductor according to claim 1, wherein:
the metal pin group further includes at least one second metal pin;
the at least one second metal pin includes a second inserting portion having a first end and second end and a second connecting portion having a first end and second end;
the first end of the second inserting portion disposed within one said insertion hole of the magnetic core so as to extend from the second end of the one said insertion hole and protrude from the first end of the one said insertion hole;
the second end of the second inserting portion is connected to the first end of the second connecting portion;
the second end of the second connecting portion is connected to the second end of the first inserting portion; and
the metal pin group is disposed around the magnetic core in a shape of coil.

3. The EMI magnetic bead inductor according to claim 2, wherein:
the metal pin group includes two said second metal pins that are located at two sides of the first metal pin; and
the second ends of the second connecting portions of the two said second metal pins are respectively connected to the second ends of the two said first inserting portions.

4. The EMI magnetic bead inductor according to claim 3, wherein:
the second end of the first inserting portion includes a first leg;
the second end of the second connecting portion includes a second leg; and
the first leg and the second leg abut against each other and are connected.

5. The EMI magnetic bead inductor according to claim 2, wherein:
the magnetic core includes at least one first limiting groove and at least one second limiting groove;
the at least one first limiting groove is communicated with first ends of two said insertion holes;
the first connecting portion is disposed in the at least one first limiting groove;
the at least one second limiting groove is communicated with the second end of another said insertion hole; and
the second connecting portion is disposed in the at least one second limiting groove.

6. The EMI magnetic bead inductor according to claim 1, wherein:
the metal pin group includes at least two said first metal pins;
the second end of one said first inserting portion of one said first metal pin is connected to the second end of one said first inserting portion of another said first metal pin; and
the metal pin group is disposed around the magnetic core in a shape of coil.

7. The EMI magnetic bead inductor according to claim 6, wherein the second end of one of the first inserting portions of one said first metal pin and the second end of one of the first inserting portions of another said first metal pin include portions bent towards each other, lapped in a row, and connected.

8. The EMI magnetic bead inductor according to claim 7, wherein:
the magnetic core includes at least one third limiting groove;
the third limiting groove is communicated with two said insertion holes; and
the second ends of two said first inserting portions of two said first metal pins are side by side in the third limiting groove.

9. The EMI magnetic bead inductor according to claim 1, wherein the EMI magnetic bead inductor comprises two metal pin groups.

10. The EMI magnetic bead inductor according to claim 1, wherein:
the metal pin group includes one said first metal pin and one third metal pin;
the third metal pin has two third inserting portions having first ends and second ends and one third connecting portion;
the first ends of the two third inserting portions are connected by the third connecting portion;
the second ends of the two third inserting portions are disposed within two said insertion holes of the magnetic core so as to extend from the second ends of the two said insertion holes and protrude from the first ends of the two said insertion holes;
the first connecting portion is disposed between the two third inserting portions of the third metal pin at an interval, and the second ends of both of the two third inserting portions are configured to be bendable towards and abut against a mounting surface of the magnetic core while avoiding the first connecting portion; and
the third connecting portion is disposed between the two first inserting portions of the first metal pin at an interval, and the second ends of both of the two first inserting portions are configured to be bendable towards and abut against the mounting surface of the magnetic core while avoiding the third connecting portion.

11. The EMI magnetic bead inductor according to claim 1, wherein:
the first metal pin is configured to have a generally U-shaped structure;
the magnetic core is configured to have a cuboid structure and include first and second side surfaces that are opposite to each other;
the insertion holes of the magnetic core pass through the first side surface and the second side surface of the magnetic core;
the first ends of the insertion hole are located on the first side surface of the magnetic core;
the second ends of the insertion holes are located on the second side surface of the magnetic core;
the magnetic core includes a winding region around which the plurality of insertion holes are distributed; and
the two first inserting portions of the first metal pin pass through the two said insertion holes and are disposed around the winding region.

12. The EMI magnetic bead inductor according to claim 1, wherein:
the magnetic core includes a winding region configured to have a cuboid structure;
the plurality of insertion holes of the magnetic core are arranged in two rows at intervals along a length direction X of the winding region;
the metal pin group further includes at least one second metal pin having a generally L-shaped structure;
the at least one second metal pin includes a second inserting portion having a first end and second end and a second connecting portion having a first end and second end;
the first connecting portion of the first metal pin is along one side of the magnetic core along a width direction Y of the winding region;
the second connecting portion of the second metal pin is along on an opposite side of the magnetic core along the width direction Y of the winding region; and
the second inserting portion of the second metal pin and the first inserting portion of the first metal pin are connected to each other along the opposite sides of the winding region, whereby the metal pin group is disposed around the magnetic core in a shape of coil.

13. The EMI magnetic bead inductor according to claim 1, wherein:
the metal pin group includes at least two second metal pins located on two sides, respectively, of the first metal pin;
each second metal pin includes a second inserting portion having a first end and second end and a second connecting portion having a first end and second end; and
the second ends of the second connecting portions of the at least two second metal pins are connected to the two second ends of the two first inserting portions, respectively, thereby forming a coil structure with at least two turns around the magnetic core.

14. The EMI magnetic bead inductor according to claim 1, wherein:
the EMI magnetic bead inductor includes two metal pin groups such that the EMI magnetic bead inductor includes four pin ends; and
the magnetic core includes two groups of the insertion holes, each of which includes four insertion holes distributed in a parallelogram array.

15. The EMI magnetic bead inductor according to claim 14, wherein:
two first inserting portions of one first metal pin are within two insertion holes in a middle or the parallelogram array; and
two second inserting portions of two second metal pins are within two insertion holes respective on two sides of the parallelogram array.

16. The EMI magnetic bead inductor according to claim 14, wherein:
the first metal pin includes four first metal pins; and
the second ends of the first inserting portions of the four first metal pins pass through a base of the magnetic core to form four pin ends.

17. The EMI magnetic bead inductor according to claim 1, wherein the metal pin group further includes a third metal pin configured to have a generally U-shaped structure;
the third metal pin includes two third inserting portions having first ends and second ends and one third connecting portion;
the plurality of insertion holes of the magnetic core includes four insertion holes distributed in an isosceles trapezoid array;
the two first inserting portions of the first metal pin are within two insertion holes that are diagonally distributed in the isosceles trapezoid array;
the two third inserting portions of the third metal pin are within the other two insertion holes that are diagonally distributed in the isosceles trapezoid array;
the second ends of the two first inserting portions of the first metal pin form two pin ends of the EMI magnetic bead inductor;
the second ends of the two third inserting portions of the third metal pin form two other pin ends of the EMI magnetic bead inductor, such that the EMI magnetic bead inductor includes four pin ends; and
the magnetic core includes a fourth limiting groove in which the four pin ends are disposed.
